(19) United States
(12) Patent Application Publication
(10) Pub. No.: US 2007/0076260 A1
(43) Pub. Date: Apr. 5, 2007

(54) COLOR MANAGEMENT SYSTEM TOOL AND METHOD

(76) Inventor: Stephen D. Upton, Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/469,444

(22) Filed: Aug. 31, 2006

Related U.S. Application Data
(60) Provisional application No. 60/713,933, filed on Sep. 2, 2005.
(60) Provisional application No. 60/713,890, filed on Sep. 2, 2005.
(60) Provisional application No. 60/713,893, filed on Sep. 2, 2005.

(51) Int. Cl. G06F 15/00

(52) U.S. Cl. 358/3.21; 358/1.9

(57) ABSTRACT

A system method and apparatus includes logic to render a first image corresponding to a first process image, and a second image corresponding to a second process image, in the same instantiation in the same graphical user interface. The second image may correspond to the first image in that it has been converted though use of a color conversion algorithm from the first image. In addition color profiles are made possible to simulate output on a greater that four channel destination device on a four or less channel proofing device wherein the profiles appear to be a four or less channel profiles. Over inking on certain devices is avoided.

### RELATED APPLICATIONS

This application claims the benefit of U.S. Provisional application No. 60/713,933, filed on Sep. 2, 2005; U.S. Provisional application No. 60/713,890, filed on Sep. 2, 2005; and U.S. Provisional application No. 60/713,893, filed on Sep. 2, 2005.

### FIELD OF THE INVENTION

Embodiments of the invention relate generally to color management in image production, and, in particular, to a system, a tool, and a method for managing color and color workflows.

### BACKGROUND

Color graphics today, whether they are captured by a digital camera, displayed on a screen or printed on paper, are typically encoded using either Red, Green and Blue color mixtures (RGB) or Cyan, Magenta, Yellow and Black inks (CMYK). Due to the different technologies and physical substances used in today's graphics devices, sending the same RGB or CMYK numbers to different devices results in different colors. A device-independent color measurement system has been created that allows numbers to be assigned to colors and the entire range of human perception is quantified by these numbers. The International Color Consortium (ICC) has created a translation system, the ICC color profile, which is used to convert between device-specific numbers, like CMYK and device-independent color numbers, such as the L*a*b* (Lab) color space. In a color managed system each device is subjected to a battery of measurements and subsequently an ICC profile is produced. This profile can be used in two ways: to translate colors requiring output from Lab to the device's numbers (such as CMYK) and to translate device numbers which are to be sent to the device (or came from the device) into color Lab numbers. Used in these manners, ICC profiles are used to get accurate, pleasing output from a graphics device as well as simulate the output device's behavior on a separate device, such as when a CMYK file is soft-proofed on a graphics display.

When ICC profiles are applied to graphics in a typical workflow, they are applied in pairs. The source profile translates from the file's color values (such as a digital camera's RGB values) to Lab values i.e., the “Profile Connection Space.” The destination profile then translates those Lab values to the output device's numbers (such as CMYK for a printing press). This ability to combine profiles “on the fly” is one of the strengths of a color managed system. Unfortunately, if the results suffer from a color cast or other flaw, diagnosing the problem is challenging as its source could lie in either the source or destination profiles, or both. Isolating each profile for testing requires a specific set of software tools and a clear understanding of the color system's architecture. The tools currently available are rudimentary at best and the level of understanding of such techniques in the industry is lacking, even at the highest levels of field technicians.

Many printing systems involve more than the typical four CMYK inks used in SWOP (Specification for Web Offset Publications), GRACoL (General Requirements for Applications in Commercial Lithography) and other standard printing processes. One of the better known is Pantone's Hexachrome six color inkset that adds orange and Green ink colors to CMYK creating CMYKOG. The packing industry is known for using seven, eight, even nine channels for printing. The ICC specification supports up to 16 channels although many commonly available profiling tools only generate profiles with up to 10 channels.

Professional desktop publishing applications such as Quark Xpress, Freehand and the Adobe CS2 suite, the newest versions currently available, support only RGB and CMYK process color profiles. In order to create multicolor files within Photoshop, for example, additional software in the form of plug-ins typically is required. Typically, this software only supports the Hexachrome color space, although there are a couple of plug-ins that will support profiles with higher channel numbers. These plug-ins are supported in a limited number of applications, typically only Photoshop and Illustrator. As a result soft and hard proofing multichannel profiles is difficult or impossible. Creating separations into multichannel files is also limited in similar ways.

In multi-ink printing systems most colors are produced by layering different inks in varying amounts. In a 4-channel printing system, such as process CMYK, cyan, magenta, yellow and black inks are used in amounts varying from 0 to 100% in each channel. When layering inks this translates to a situation where up to 400% ink coverage can occur in some areas. In most CMYK printing systems, four full layers of ink is unnecessary (maximum darkness is often achieved with 300-350% coverage) and can create mechanical issues such as soaked paper, broken paper webs, long drying time and so forth.

When CMYK colors are created for a particular printing system, the color management system limits the total ink possible to a user-specified value. Images and colors converted using this system have the appropriate balance of inks to achieve the desired color appearance while remaining below the total ink coverage specified by the user.

A simple fact of printing workflows and customer/printer relationships today is that the settings used by, for example, a customer to create CMYK are often not appropriate for the printer's press system. A good example of this is in the newspaper industry. The web (roll) paper used in printing newspapers is typically relatively inexpensive, grainy and absorbent. As a result, it does not accept heavy inking and in fact, over-inking can weaken the paper causing a break in the web, especially when run at a high speed, potentially causing equipment damage and press operator injury. CMYK created properly for newsprint will typically have a total ink limit somewhere around 280% keeping the print job within a safe range.

The capability of a device to print or render an image is described by the device's gamut. A device able to display many colors is typically described as having a large gamut; conversely, a device able to display fewer colors is described as a smaller gamut. A color in one device's color space that the second device is incapable of displaying is considered out-of-gamut for the second device. Similarly, a color that a device is capable of displaying is considered in-gamut. Different techniques are used to adjust out-of-gamut colors to bring them in-gamut. These techniques are typically referred to as “Rendering Intents.” Four versions of Rendering Intents may be used: Perceptual; Saturation; and two versions of Colorimetric Intents generally referred to as Relative Colorimetric and Absolute Colorimetric.

When using the Saturation Rendering Intent each out-of-gamut pixel is treated individually without regards to any surrounding pixels. Each color out-of-gamut is simply moved to the closest in-gamut color. In addition some pixels that are in-gamut may be changed in order to increase the color saturation near the adjusted previously out-of-gamut pixels in order to effectively increase the saturation of the image.

When using the Perceptual Rendering Intent, the entire gamut is compressed to fit the outlying colors into the gamut of the destination device. However, all the colors that were actually already in-gamut will be compressed, as well in proportion to the out-of-gamut colors. Since all of the colors are adjusted proportionately, even the colors that the destination device could accurately reproduce are changed. The intention is to maintain relative differences between the colors. The Perceptual Rendering Intent is typically the most commonly used rendering intent.

When using either Relative or Absolute Colorimetric Intents, only the colors that are out-of-gamut are compressed. In addition, all of the colors that are in-gamut are not compressed but instead, may be adjusted for accuracy. Using the Colorimetric Rendering Intent to convert from a larger color space to a much smaller color space can introduce problems such as posterization and banding into the destination image. Both the Relative and Absolute Intent treat all colors the same way except for the white point. With the Relative Colorimetric, the white point of the source color is mapped, or changed to the paper white of the destination. By contrast when using the Absolute Colorimetric the white point of the destination becomes the white point as represented by the source profile. The white point is the absences of color which may be illustrated as white in a medium able to display white but may be the color of paper i.e. paper white on a hard copy.

### DEFINITIONS

Reference color space: the color space which represents the final printing condition that is desired to be simulated on another device. In this example, it is the CMYKOG multi-ink printing press which we will simulate on the RGB printer.

Separation rendering intent: the ICC rendering intent (color mapping setting) which determines how colors, especially out-of-gamut colors are modified (mapped) to the reference colorspace.

Proofing rendering intent: the ICC rendering intent which determines how the gamut of the reference printing system will be simulated on the RGB printer. Typically absolute colorimetric and relative colorimetric are the two choices and they determine if the reference printing system's paper white color is simulated or not (respectively) on the RGB printer.

Abstract color profile: A profile created either manually or by computer wherein a particular effect is created. For example, a sepia tone effect, or perhaps all orange colors are made more red. Various effect are possible.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a schematic diagram in accordance with various embodiments of the present invention;

FIG. 2 illustrates a schematic diagram in accordance with various embodiments of the present invention;

FIG. 3 illustrates a schematic diagram in accordance with various embodiments of the present invention;

FIG. 4 is a flowchart illustrating various methods for use to practice various embodiments of the present invention;

FIG. 5 is a block diagram illustrating various methods for use to practice various embodiments of the present invention;

FIG. 6 is a block diagram illustrating various methods for use to practice various embodiments of the present invention;

FIG. 7 is a flowchart illustrating various methods for use to practice various embodiments of the present invention;

FIG. 8 is a flowchart illustrating various methods for use to practice various embodiments of the present invention;

FIG. 9 is a block diagram illustrating various methods for use to practice various embodiments of the present invention;

FIG. 10 is a flowchart illustrating various methods for use to practice various embodiments of the present invention;

FIG. 11 illustrates a schematic front view in accordance with various embodiments of the present invention; and

FIG. 12 illustrates a schematic diagram in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB),” that is, A is an optional element.

The phrase “in one embodiment” is used repeatedly. The phrase generally does not refer to the same embodiment; however, it may. The terms “comprising,” “having,” and “including” are synonymous, unless the context dictates otherwise.

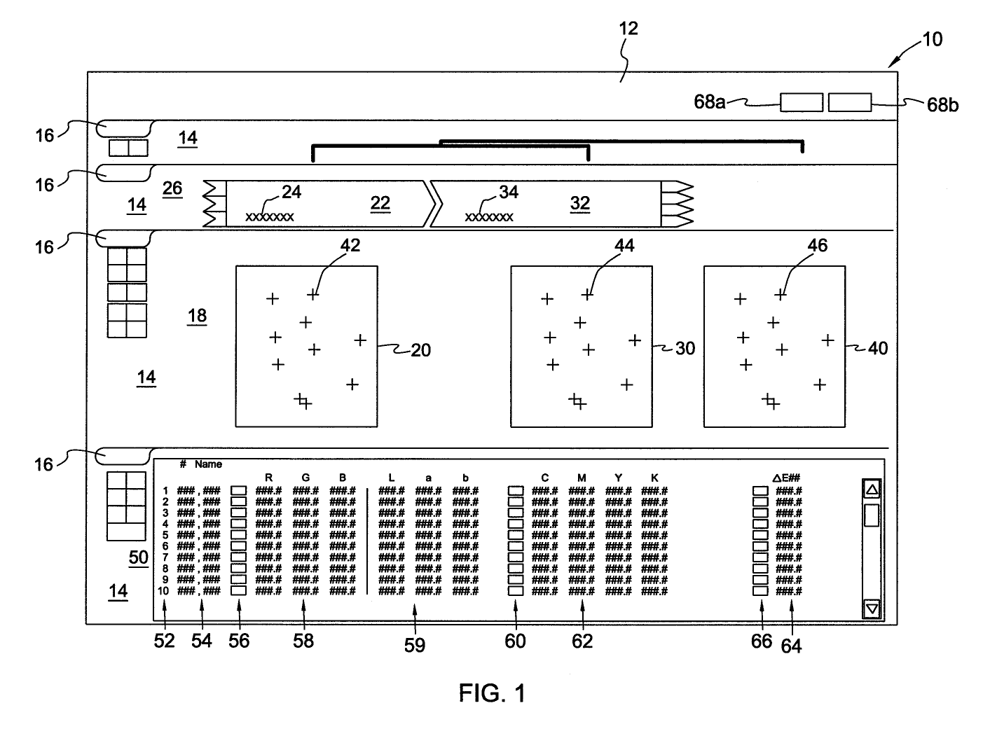

FIG. 1 is a schematic diagram illustrating various embodiments in accordance with the present invention. A system 10 may include a user interface 12 which may be created by, for example, software, or firmware, according to various embodiments of the present invention. The user interface 12 may include multiple user interface elements, for example, display or output units and/or input units. Various interface units may include horizontal regions 14, which may be expanded and collapsed with expand/collapse interfaces 16 such as, for example, drop-down menus, pop-up windows, interface elements, and the like. The horizontal regions may illustrate information regarding color management topics including, but not limited to, workflows, profiles, images, and colors.

For example, an image interface region 18 may include a first image 20 which may be rendered in one or multiple instantiations of the user interface 12. The first image may be from a source device, for example, a digital camera. The first image 20 may be rendered in a first color standard and may use a first profile. The profile name may be displayed in a profile interface 22 with text 24 in a profile interface region 26. A second image 30 may be rendered in the same instantiation of the same user interface 12 as the first image 20 was rendered. A second profile may be used to render the second image 30 as indicated with text 34 in second profile interface 32. Differences may be present between the first image 20 and second image 30. The differences may be rendered as a third image 40 in the same instantiation as the first image 20 and the second image 30 and the same user interface 12. The third image 40 may be referred to as a delta image.

In various embodiments, one or more pixels may be selected as indicated with pixels selectors 42. In the example shown, ten pixels are selected in the first image 20. Corresponding pixels are indicated with pixels indicators 44 and 46 in the respective second image 30 and third image 40. Numeric color values for each selected pixel may be represented in a value interface region 50. A list may include a pixel identifier by, for example, a number 52; and/or a pixel coordinate 54; and/or a pixel color swatch 56. Each selected pixel may be represented in different color spaces. For example, they may be represented in a device specific color space with, for example, RGB numbers 58, and their equivalent device independent color space values, for example, with Lab numbers 59. Similarly, the corresponding pixel from the second image 30 may be represented with second image swatches 60. The color values in the color space of the second image 30 may also be represented with device specific numbers, for example, in CMYK numbers 62. In various embodiments, the user can select pixels in any of the images.

The numeric differences of each pixel selected in the respective first and second images 20, 30 may be represented with delta values 64. Each respective color difference may also be represented by delta swatches 66. The color delta values 64 may be determined using color differencing equations including, but not limited to, delta-E76, delta-E94, and CMC. A user may select which color differencing equation to use with delta interface elements 68a and 68b, for example, user interface buttons.

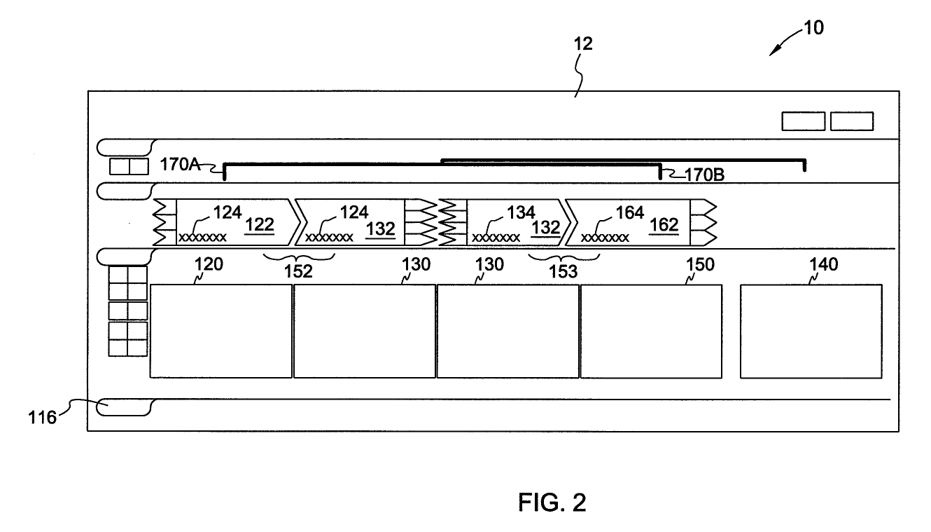

FIG. 2 is a schematic diagram illustrating a user interface 12 in accordance with various embodiments of the present invention. A first image 120 and a second image 130 are both being rendered in the same instantiation of the user interface 12. Each may be rendered according to a respective first profile 122 and second profile 132 as indicated with respective profile labels 124, 134. The first and second profile labels 124 and 134 may also be represented as a pair as illustrated in this example embodiment. The firs and second and may represent a first workflow segment 152 wherein an image is taken from a first part, or node, of a workflow, and modified or “brought to” a second part or node in the workflow. The second image 130 may be duplicated as part of a second work flow segment 153. A third image 150 may be rendered in the same instantiation of the user interface 12 as the first image 120 and the second image 130. The third image 150 may be rendered in accordance with a profile selected and identified with label 164 in profile window 162. Differences may be present between the first image 120 and second image 130, between the first image 120 and the third image 150, and/or between the second image 130 and the third image 150. Any of these differences may be illustrated as a rendered difference, or delta, image 140 in the same instantiation of the user interface 12 as the respective first image 120, second image 130 and third image 150. Which difference to be displayed may be selected by the user by moving workflow, by for example using a computer mouse selectors 170A and 170B. The example instantiation of the example embodiment, shows the first image 120 and the third image 150 as having been selected. Therefore the difference image 140 shows the difference between image 120 and image 150. Numeric color values may be viewed by, for example, clicking with the expand/collapse button 116. The example shows the values interface region collapsed. Various embodiments may include more than one delta image to illustrate more than one difference between rendered images.

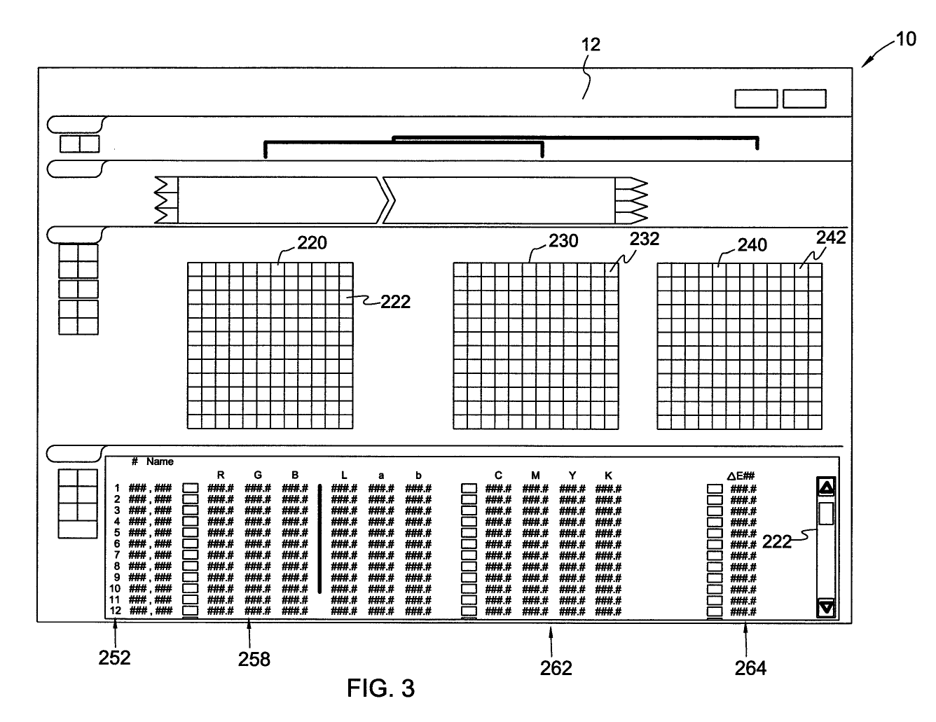

FIG. 3 is a schematic diagram illustrating a user interface 12 in accordance with various embodiments of the present invention. A first image of a target 220, for example, a calibration target has been rendered. Calibration targets may be used to calibrate, recalibrate or confirm the capability of a device to display certain colors. The target 220 may have multiple patches 222. Each may be a different color rendered as a representation of the capability of a first device (not shown). Numeric values corresponding to the colors of each patch 222 may be listed in value list 258 as color space values of the device. In various embodiments, the target may be a scanned or measured target rendered in the user interface 12. The target 220 may be scanned or measured from a hard copy output of the device. In various other embodiments, the target 220 may be rendered from target values that have been input, copied, downloaded, or the like. Each patch 222 of the target may have a patch identifier 252 similar to the pixel identifiers in a previously described embodiment.

A second image of a second target 230 may be rendered in the same instantiation as the first image of the first target 220. Numeric values of each of the patches 232 of the second target 230 may be listed in a second numeric value list 262 similar to the second pixel list in previously described embodiments. A delta target 240 may also be rendered in the same instantiation as the first target 220 and the second target 230 are rendered. The third target may illustrate a delta between the first target 220 and the second target 230. Numeric values of the delta between the patches may be listed in a delta list 264 similar to the delta list described in previously described embodiments. The differences may be represented with delta patches 242.

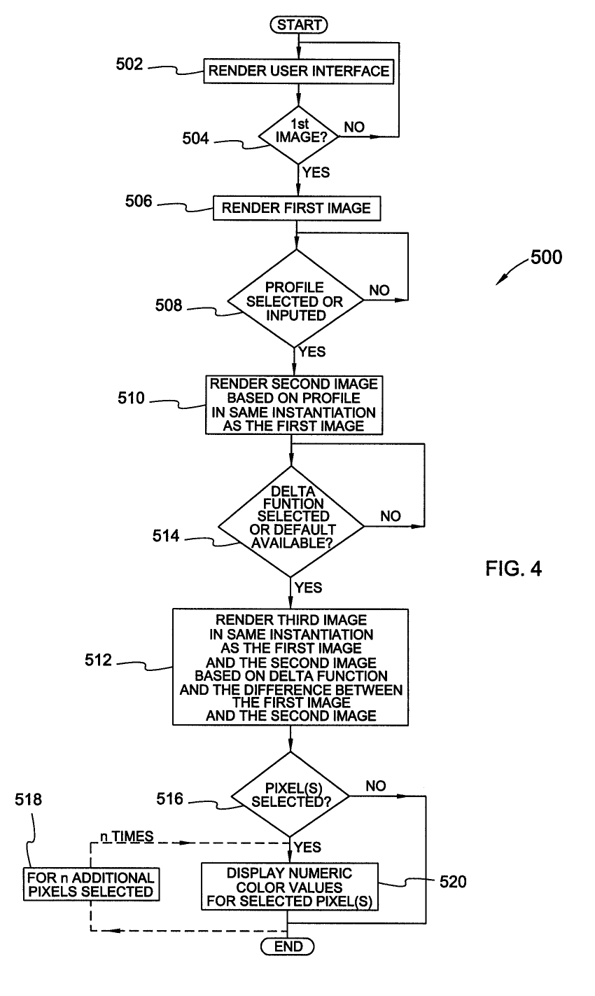

Referring now to FIG. 4 wherein a flowchart of selected operations for color management, and/or color workflow management logic for a method for implementing a system 500 in accordance with various embodiments of the invention is illustrated. As illustrated, when operated by, for example, a processor, the logic 480 of the system 500 may first render a root level of user interface 502 having a number of user interface elements including a user interface element to facilitate a user in loading a first user image into the system 500. Such loading may be prompted as illustrated with 504. Thereafter, the method may include rendering a first image corresponding to a first process image in a first instantiation of a graphical user interface 512. The user may then be prompted to selected a profile, 508, or to input a profile, or a default profile may be available. The method may then further include rendering a second image corresponding to a second process image in the same instantiation in the same graphical user interface 510.

Various embodiments may include rendering a third image corresponding to a difference between the first process image and the second process image, 514. The user may then be prompted to select delta function, or difference function 512, or a default profile may be available. Various embodiments may also include displaying pixel information based on user selected pixels 516 in, for example, a color list. Embodiments may include displaying a color list based on the selected pixels in the first, the second, or the third process image. The color list may populate with each of “n” pixels selected as illustrated in the dotted line branch 518, or the list may populate after the set of pixels is selected as illustrated with branch 520.

As discussed further herein, various embodiments may further comprise rendering an over-inked image including pixels that if printed on specified equipment would have ink quantities over a preselected threshold. The preselected threshold may be determined from the device and paper combination characteristics.

Also discussed in further detail herein with regard to various other embodiments, the second image may correspond to a simulated device profile created by concatenating a source profile for a second device, for example, a proofing device with an abstract profile created from a round-trip profile from appearance values to the device values of a third device and from the device values of a third device back to appearance values.

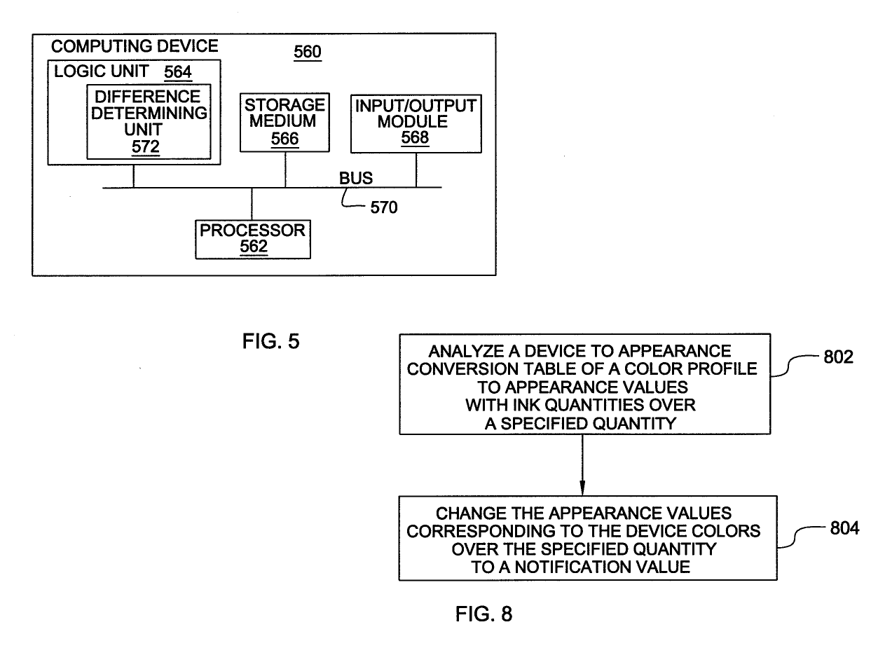

FIG. 5 is a block diagram illustrating various embodiments according to the present invention. An apparatus, for example, a computing device 560 may include a processor 562 and a color management logic unit 564 adapted to be operated by the processor 562 to facilitate receiving a first set of image data. In various embodiments, the color management logic unit 564 may be adapted to convert the first set of image data to a second set of image data, and may be adapted to hold the converted image data in a storage medium 566. In other embodiments, the color management logic unit 564 may be adapted to input the second set of image data into the storage medium, via, for example, an input/output module 568. The second set of image data may be created from the first set of image data through the implementation of a color space conversion algorithm, for example, a color profile. The color management logic unit 564 may be adapted to be operated by the processor 562 to facilitate a rendering of a first image based on the first set of image data and a second image based on the second set of image data in the same instantiation of a graphical user interface. The color management logic unit 564, the storage medium 566, and the input/output module 568 may be adapted to be coupled with the processor 562 via a bus 570. Other coupling, logic components, and arrangements may be used with this embodiment and other embodiments.

In various embodiments, the computing device 560 may further comprise a difference determining unit 572 adapted to be operated by the processor 562 to facilitate determining a difference between the first set of image data and the second set of image data. The difference determining unit 572 may be adapted to display the difference in the graphical user interface in a same and second instantiation wherein the difference is represented using one or both of a rendered difference image or numeric difference values.

In various embodiments, all, or portions of, one or more instantiations of the user interface may be out put to a medium, for example, paper, in the form of a worksheet. The information may include device-space color information and device independent color information, and may be in the form of measurements or images. Various embodiments according to the present invention may have the ability to transform this data using ICC color profiles. The device-space color information may refer to colors specified relative to a device, such as RGB, CMYK, etc. Other color information may be specified by “appearance” numbers like Lab.

Referring again to FIGS. 1-3 the user interface 12 may have the ability to display ICC profiles, images and lists of colors simultaneously in a clear and meaningful way. Using the interface or the worksheet, a user, for example, a technician, can lay out or “model” an entire graphics workflow from image source to final destination. Problems in the work flow may be isolated, for example, the effect of individual ICC profiles, and may help inform a technician where to apply efforts to correct the problem. Such efforts may include but may not be limited to troubleshooting regarding profile errors or device errors.

The user interface may also have the ability to display multiple workflows and portions of workflows simultaneously and to compare their results. Embodiments may be flexible and may include features that can be used to simply compare two sets of measurements, for example, to see how two devices differ, or how one device's output fades over time, or to transform the same source colors through two different sets of profiles and then compare the end results. The list of possible embodiments may be quite numerous. Embodiments of the color worksheet may be designed to be an endlessly configurable tool that may be transformed by the end user into a color and workflow tool to meet various requirements.

Embodiments according to the present invention may include the ability to display color data simultaneously as a list and an image—regardless of whether the original source data is a list of colors or an image. Color lists may appear as 2D arrays of patches and images appear as a list of their constituent colors or a subset thereof.

Embodiments may include colors and images that may be transformed using ICC profiles or other transformation mechanisms and the results displayed beside the source colors. This may be repeated multiple times creating multiple columns of information depicting a model of a graphics workflow. Embodiments may enable any two columns of data to be selected for comparison and calculation of color differences or other statistical analysis.

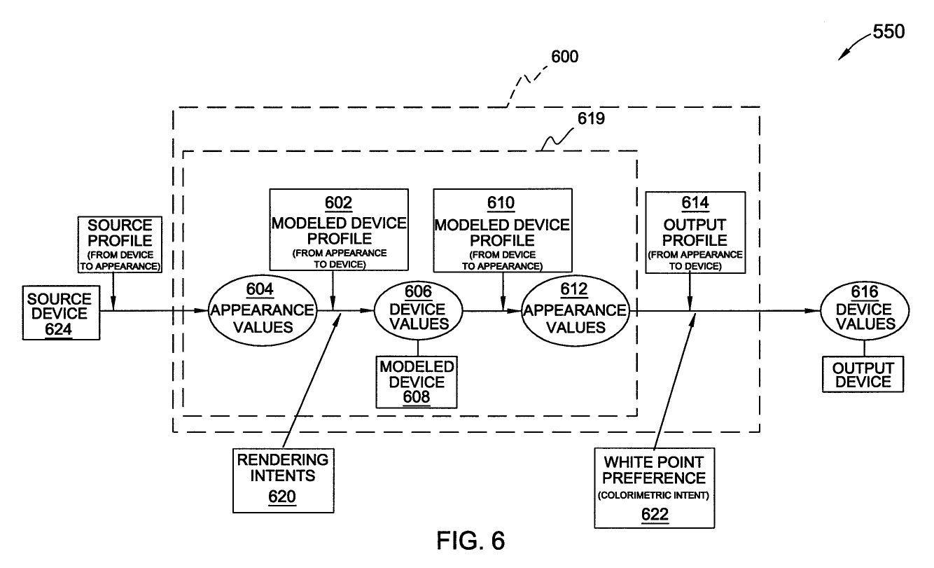

FIG. 6 is a block diagram illustrating various embodiments in accordance with the invention. A color profile 550 may include a first color space conversion algorithm 602 adapted to convert a first set of appearance color values 604 to a first set of device color values 606 specific to a modeled device 608. A second color space conversion algorithm 610 may be adapted to convert the modeled device color values 606 to a second set of appearance values 612. A third color space conversion algorithm 614 may be adapted to convert the second set of appearance values 612 to a second set of device color values 616 specific to an output device 618. Collectively the blocks within the larger dotted line rectangle may be referred to as a modeling profile 600.

Implementing the conversion facilitated by the first color space conversion algorithm 602 and then by the second color space conversion algorithm 610 may be referred to as a “round-trip profile” 619. Components of the profile may be resident on or created by a computing device. The computing device may include, but are not limited to, personal computers (PCs), laptop computers, personal digital assistants (PDAs), and the like.

Embodiments of the present invention may encapsulate a “round-trip” color value conversion into a modeling profile that may be used as a standard profile. When an ICC profile is used for printing, the Lab to device B2A tables in the profile translate from Lab color appearance numbers to device numbers (CMYKOG for example). When the profile is used for proofing, an entirely separate set of tables within the profile may be used for translation from device numbers (CMYKOG) to color appearance Lab numbers. One method of proofing may be applied to files that are in their original color spaces. The “reference” profile may be first used to translate color from Lab-to-device values. It is then applied again in reverse, converting the color values from device values back to Lab.

A “round-trip proof” follows the path of Lab→device→Lab. From the outside, these two concatenated transformations can be considered as (and stored in) an abstract ICC profile. Abstract profiles contain a 3D color transformation (such as a proofing transformation) and use Lab as the source and destination spaces.

The printing portion of a regular ICC device profile converts from Lab to device values. If a profile is created where the round-trip abstract proofing profile is concatenated with the device profile, then color Lab values will first undergo the proofing transformation before they are converted to device space for output. This may be referred to as a “modeling” profile as it models a separate system in addition to performing its normal output function. The paths may be described as follows:

“Normal” Device Profile: Lab→output device

“Round-Trip” transform: Lab→modeled device→Lab

“Modeling” profile: Lab→modeled device→Lab→output device

Once the concatenation is complete, the resulting profile may still convert from Lab→device, appearing to be a normal device profile, usable where all ICC-compatible profiles can be used.

Regular ICC device profiles may contain up to three unique color tables for the perceptual, saturation and colorimetric rendering intents. These tables may map in and out-of-gamut colors with different weightings depending on user preference. The white point tag in the profile records the white point of the original profiled medium and the application of this white point to the colorimetric intent produces the two variations of relative colorimetric and absolute colorimetric. By these means, the white point tag and three tables create four distinct rendering intents.

In order for a modeling profile to reflect different rendering intents of the _reference_profile, three separate links may be formed as described above, except the intent chosen in the first “Lab→modeled device” transformation may be varied. A user may also be given the ability to select the relative or absolute colorimetric intents for the final Lab→device transformation. This results in building white point simulation into the modeling profile at creation time.

Embodiments of the present invention may further include a first input interface 620 adapted to modify the first color space conversion algorithm according to user specified rendering intents. The user-specified rendering intents may be one of saturation rendering intents or perceptual rendering intents.

Other embodiments of the present invention may further include a second input interface 622 adapted to modify the second set of device color values according to user specified rendering intents. The user specified rendering intents may be one of absolute colorimetric rendering intents or relative colorimetric rendering intents.

Various embodiments may include a profile wherein the first set of appearance color values originate from a source device 624.

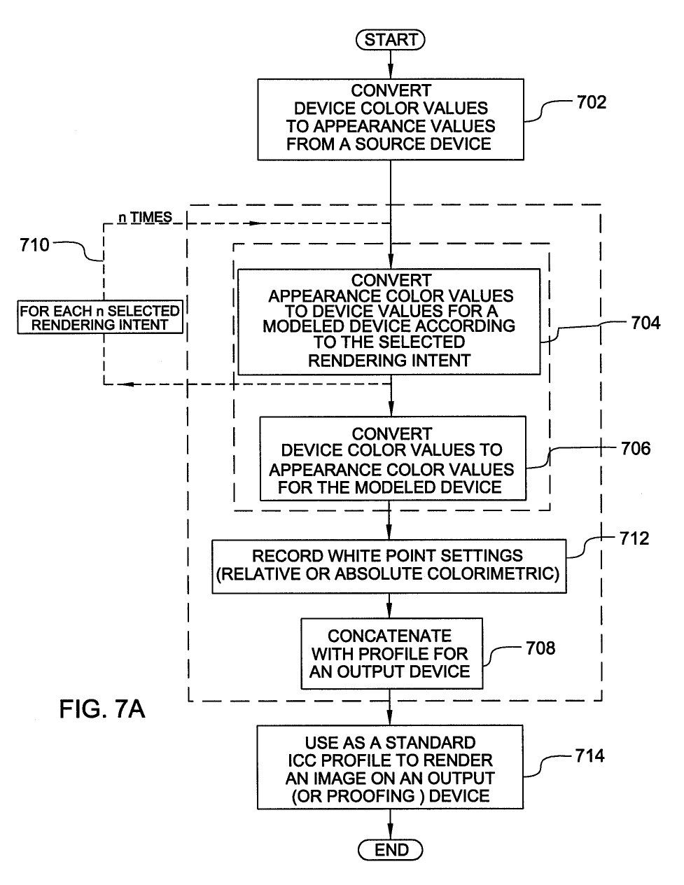

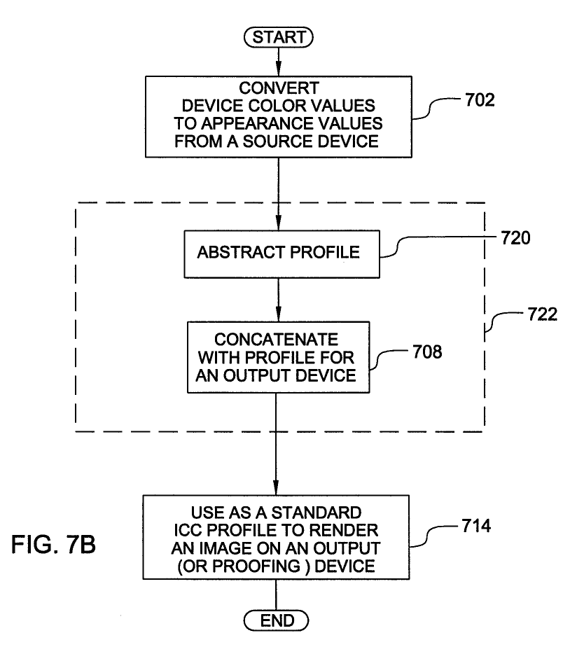

Referring now to FIG. 7, a flowchart illustrating a method in accordance with various embodiments of the invention is illustrated. The method may include:

converting appearance color values to device values for a modeled device 702;

converting a first set of appearance color values to device color values for a modeled device 704 according to a selected rendering intent. Various rendering intent may be selected. For each intent block 704 may be repeated, “n” times, 710. A conversion table may be created each time;

converting the modeled device color values to a second set of appearance color values 706; and

concatenating the second set of appearance color values with a profile for an output device 708.

In various embodiments, a method according to the present invention may further comprise modifying the first set of appearance color values according to user specified rendering intents, 710, for example, saturation or perceptual rendering intents. In various embodiments, a method according to the present invention may further comprise modifying the concatenated output device profile according to one of relative colorimetric rendering intents or absolute colorimetric rendering intents, 712. In various embodiments the resulting “modeling profile” may be used as a standard ICC profile, 714.

FIG. 7B. Is a flow chart illustrating a method according to various embodiments in accordance with the invention. The method may include embedding at least a color effect portion of one of an abstract profile 720 into a second color profile intended for use with a second device to form a third profile 722. In various embodiments, various numbers of abstract profiles may be embedded into a second profile.

The Lab→modeled device→Lab transformation may be encapsulated into a Lab→Lab transformation, the type of device space modeled is invisible to the overall transformation. This means that any ICC device space—up to any number of channels, for example, 16 channels—can be “round-tripped” and encapsulated into the Lab→Lab transform. This also means that regular ICC device profiles that are compatible with publishing applications may be modified using techniques according to various embodiments of the present invention to “proof” multichannel printing systems while keeping the complexity of the multichannel systems invisible.

An example implementation of one embodiment of the present invention may include a user having a wide-gamut inkjet printer onto which they would like to proof a Hexachrome 6-channel printing system. The 6-channel profiles may not be compatible with, for example, Adobe Photoshop. One embodiment of the present invention may include a tool to be used to select the 6-channel reference profile and the ICC device profile for the inkjet printer. The tool builds a modeling profile by concatenating the Lab→6-channel→Lab proofing transform to the inkjet profile. It does so once for each rendering intent, varying the intent set in the Lab→6-channel portion of the transform. This modified “modeling” profile is a fully ICC-compliant “normal” ICC device profile and may simply be substituted for the original inkjet profile when the user prints to the inkjet. Instead of creating an accurate match of original file colors to the inkjet, however, the modeling profile simulates the gamut and tonality of the Hexachrome printing system on the inkjet. In short, it proofs Hexachrome on the inkjet without Photoshop or the printer drivers possessing the ability to deal with 6-channel profiles and without the need for any additional software plug-ins on the user's system.

Embodiments of the present invention may provide the ability to embed specific color transformations within an existing ICC profile, altering its functionality but allowing it to remain a standard ICC profile, usable by any ICC-compatible color management system.

One embodiment may enable a user to soft-proof a 7-channel press profile in Adobe InDesign CS2. As InDesign may not support 7-channel profiles, a modeling profile may be required. Embodiments in accordance with the present invention may be used to select the 7-channel press profile and an RGB workingspace profile that was the same as the workingspace in the user's RGB files or a large enough gamut to contain the user's RGB files (to avoid clipping the gamut). Embodiments may then build a modeling profile by concatenating the Lab-to-7-channel to-Lab proofing transforms with the Lab-to workingspace transform. After concatenation and saving the profile to disk, the user may simply select the new modeling profile in InDesign's proof setup and they may be able to soft-proof the 7-channel press system with no additional software.

A user may wish to apply abstract profiles in Photoshop, for instance, using one embodiment of the present invention. The user may need only to build a modeling profile where the user may concatenate their abstract profile with their RGB workingspace profile. The resulting RGB profile may then be applied to the user's file, which would subsequently apply the encapsulated abstract profile.

One embodiment according to the present invention may provide the effects of complex and incompatible multichannel profiles encapsulated within regular, widely supported ICC profiles. Any ICC-compatible system may be able to utilize to positive effect the benefits of the multichannel profile embodiments of the invention without any additional requirements.

In one embodiment, the multiple rendering intents in a multichannel profile may be captured in the modeling profile and may include the ability to simulate press white-point on the output device.

In one embodiment abstract profiles that are incompatible with major publishing applications may be concatenated with working space profiles to produce fully compatible device profiles that apply the encapsulated transformation.

In one embodiment 6-channel CMYKOG (Cyan, Magenta, Yellow, Black, Orange, Green) profile may be used as the reference and an RGB printer profile as the destination space.

In a color-managed proofing system, ICC profiles may be used to simulate the final printing process on a less expensive and much faster printer. Two profiles may be used for this process. The source “reference” profile represents the final printing process that is to be simulated. The source profile is responsible for converting the incoming CMYK data to Lab—effectively describing the color appearance of the CMYK values on press. The destination profile is responsible for translating the Lab color appearance numbers into CMYK (or other) values appropriate for achieving the desired numbers on the proofing device.

An example implantation of various embodiments accordance with the invention may include:

1. Constructing a series of color transformations. The transformations may begin with the Lab colorspace, convert to the CMYKOG colorspace using the separation rendering intent and the CMYKOG profile, then convert back to the Lab space using the proofing rendering intent (again using the CMYKOG profile) and then finally to the printer RGB colorspace using the RGB printer profile and the proofing rendering intent; Lab colorspace→-(separation rendering intent)→CMYKOG colorspace→-(proofing intent)→Lab colorspace→-(proofing intent)→RGB printer colorspace

2. Constructing a 3D table populated with Lab values which represents the input values to an Lab table of a certain grid size. For instance, if a 3×3×3 resolution table is desired, then the Lab may vary from their minimum values to their maximum values with one midpoint value. (ie L would vary from 0 to 50 to 100);

3. Transforming the table of color values through the series of color transformations as described;

4. Populating the color entries in the 3D table with the corresponding results of the series of color transformations. This table will be used as a lookup table in the constructed modeling profile;

5. Repeating the constructing a 3D table, the transforming and the populating, with an identical copy of the 3D table a number of times, for example, a three times. Each time, may be to vary the separation rendering intent from perceptual to saturation and then relative colorimetric.

6. Creating a copy of the RGB printer profile and open it into memory. Replace the A2B0 (perceptual), A2B1(colorimetric) and A2B2(saturation) tables in the profile with the respective table created as illustrated in paragraphs labeled 1-5.

7. Retain the white point and B2A proofing tables in the profile and save it to disk.

This may result in an ICC profile that may be usable in applications as a normal RGB printer profile but may have the CMYKOG “proofing” color transformation embedded within. When the end-user selects a rendering intent in their application, the reference profile's rendering intent may be utilized in each of the RGB printer profile's tables.

FIG. 8 illustrates a method in accordance with various embodiments of the invention. The method may include:

analyzing a device to appearance conversion table of a color profile for device colors to be created with ink quantities over a specified quantity 802; and

changing the appearance values corresponding to the device colors over the specified quantity to a notification value 804.

The notification value may be referred to as an alarm color. The value may be one of a bright color, a bright red, white, or paper white.

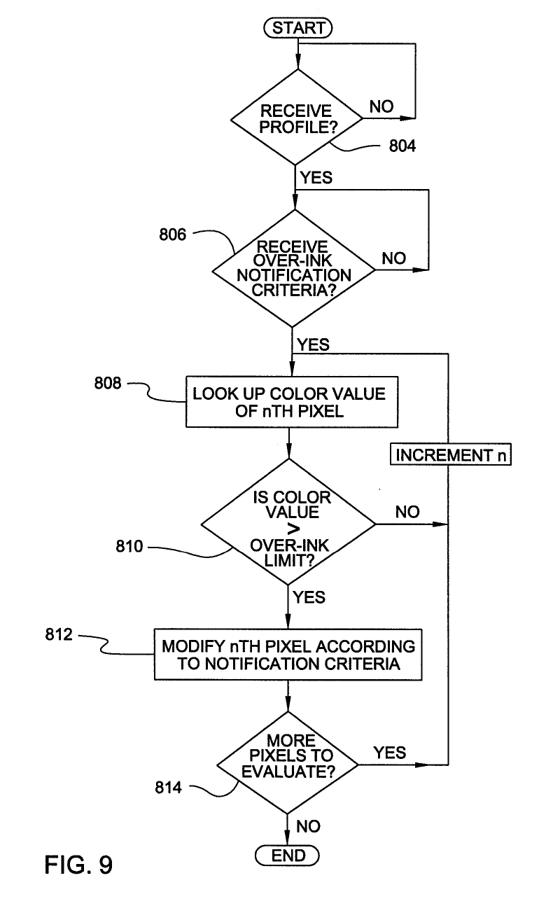

FIG. 9 illustrates a method in accordance with various embodiments of the present invention. The method may include receiving a profile 804. The method may utilize control logic that may be similar to control logic described in other embodiments described herein. The control logic may, for example, facilitate prompting a user to input a profile. The prompting may be facilitated with one or more user interface elements, which may be part of, for example, the user interface illustrated in FIG. 1. The method may further include receiving an over-ink notification criteria 806. This may occur via a prompting as previously described. The method may include looking up a color value of a device color 808, and determining if the value is greater than the over-ink threshold 810. If the color is over the over-ink threshold, the control logic may then modify the appearance value corresponding to the device value over the limit 812. The logic may loop through certain operations analyzing each color value until all the colors have been analyzed 814.

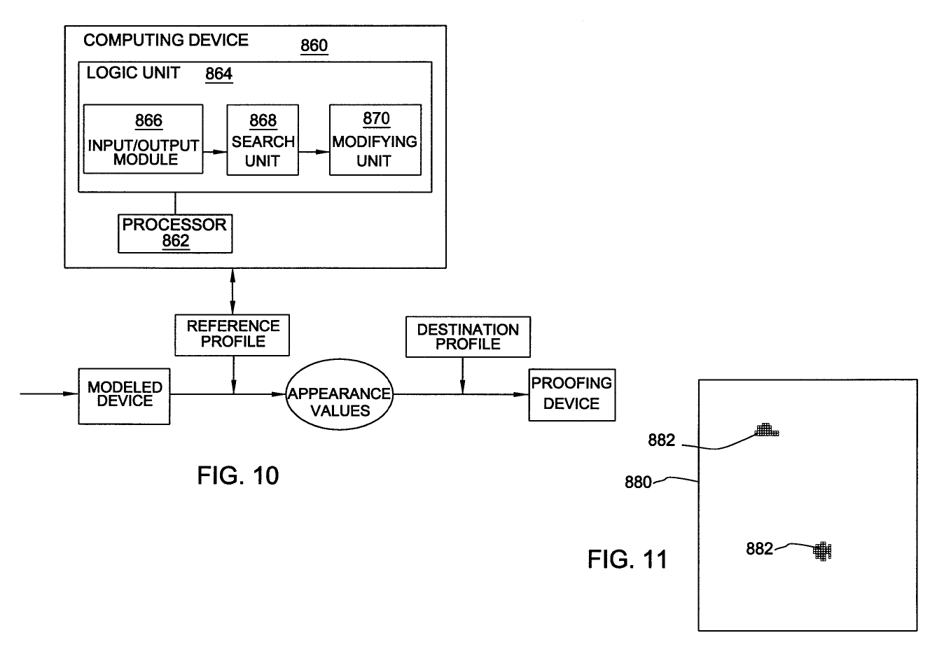

FIG. 10 is a block diagram illustrating various embodiments according to the present invention. An apparatus, for example, a computing device 860, may include a processor 862 and a logic unit 864 adapted to be operated by the processor 862. The logic unit 864 may include an input/output module 866 adapted to facilitate receiving a color profile, and adapted to receive an over-ink threshold value. The color management logic unit 864 may also include a search unit 868 adapted to search device color values for values greater than the over-ink threshold value. The logic unit 864 may also include a modifying unit 870 adapted to modify appearance color values in the profile which correspond to the device colors that are over the over-ink threshold. The input/output module 866 may be adapted to make the modified profile available to use.

In various embodiments, the input/output module 866 may be further adapted to receive a notification color value, and the modifying unit 870 may be adapted to change the appearance color values that correspond to the device colors that are over the over-ink threshold according to the notification color value.

FIG. 11 is a schematic front view illustrating an image 880 wherein pixels 882 that would have printed with too much ink have been modified to be a notification color. The image is illustrated here schematically with all other pixels not shown for ease of illustration. Although in certain embodiments the image may be rendered or printed on, for example, a proofing printer with the locations of the over-inked pixels made easy to find by only displaying or printing the over-inked pixels.

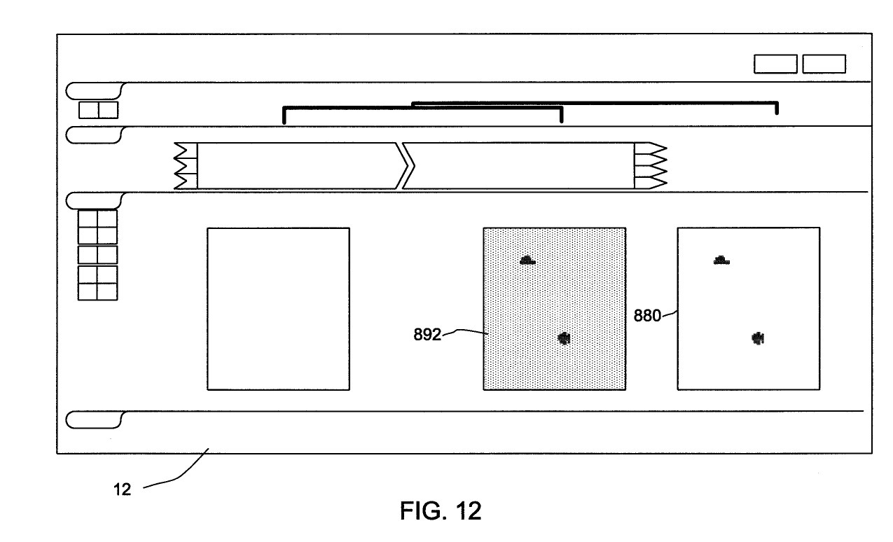

FIG. 12 is a schematic view illustrating how the user interface 12, in accordance with various embodiments, may be used to render an image 892 with pixels that would be over-ink modified to include a notification color. An additional image 880 may also be illustrated in the same instantiation with only the over-inked pixels illustrated as previously discussed above.

An embodiment of the present invention may be adapted to modify the “reference” profile in a very specific manner according to user specified parameters. In such an embodiment, a user provides the total ink limit allowed on their press and a highlight color—such as bright red, for example, to be used as an indicator of over-inked colors.

An embodiment according to the present invention may include logic adapted to open the device-to-Lab conversion tables within the profile and search for all entries that have total ink limits above the user-specified threshold. The logic may then replace the existing color appearance entry in the table with the user-specified highlight color. It then saves this modified profile to disk as a separate ICC profile. To all ICC-compatible systems, the reference profile still appears as a normal ICC profile. One embodiment may not require any changes be made to the system performing the conversions (typically a RIP—raster image processor). In an embodiment, the user-specified color is an absence of color or ink, which may leave an underlying medium, such as paper, exposed. When the original reference profile is replaced with the ink alarm profile, below-threshold colors may continue to proof normally. When an above-threshold color combination is converted, however, the highlight color may be produced. In a typical proofing situation this results, for example, in bright red areas appearing where colors are over-inked. This is an obvious display in the proof that immediately calls attention to the problem so the user can make modifications to the file prior to it going to press. Various embodiments may use the same profile in conjunction with a monitor profile to show the ink alarm display during soft-proofs.

An embodiment of the present invention may provide an existing, functional ICC profile that may be modified to perform methods in accordance with the invention and yet may still be a normal ICC-compatible profile. No additional software or techniques may be required to put this new function into production. An embodiment of the present invention may leave colors in the original ICC profile which are below the inking threshold unmodified. The profile may be installed and used for everyday proofing purposes. When the problem situation of over-inked colors is encountered the ink alarm color may show up. An embodiment of the present invention uses a user-specified highlight color to illustrate an inking problem on a proof.

In addition to the discussion of various embodiments above, figures and additional discussion are presented herein to further describe certain aspects and various embodiments of the present invention. It is to be understood, however, that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein.

What is claimed is:

1. A method comprising:
rendering a first image corresponding to a first set of image data in a first instantiation of a graphical user interface; and
rendering a second image corresponding to a second set of image data in the first instantiation in the same graphical user interface.

2. The method of claim 1 further comprising rendering a third image corresponding to a difference between the first image and the second image.

3. The method of claim 1 further comprising displaying pixel information based on user selected pixels in a color list.

4. The method of claim 2 wherein a delta image is determined by a user selected delta function.

5. The method of claim 3 further comprising displaying a color list based on the selected pixels in the first image.

6. The method of claim 1 further comprising rendering an over-inked image including pixels ink quantities over a preselected threshold, the preselected threshold being determined from the device and paper combination characteristics.

7. The method of claim 1 wherein the second image corresponds to simulated device profiles created by concatenating a source profile for the second simulated device with an abstract profile created from a round-trip profile from appearance values to the device values of the third device and from the device values of the third device back to appearance values.

8. The method of claim 1 wherein the second set of image data is created by converting the first set of image data using a color space conversion algorithm.

9. The method of claim 1 further comprising:
rendering a third image corresponding to a third set of image data in an instantiation with the first and second images, wherein the second set of image data is created by converting the first set of image data using a first color space conversion algorithm; and
wherein the third set of image data is created by converting the second set of image data using a second color space conversion algorithm.

10. The method of claim 9 further comprising:
selecting two of the first, second, or third images; and
displaying a difference between the selected two of the first, second, or third images.

11. The method of claim 10 wherein in the difference is displayed as one or both of a rendered image difference or a numeric difference.

12. An apparatus comprising:
a processor; and
a color management logic unit adapted to be operated by the processor to facilitate rendering a first image and a second image in a single instantiation of a graphical user interface, the second image being created from acting on the first image with a color space conversion algorithm.

13. The apparatus of claim 12 further comprising a difference determining unit adapted to be operated by the processor and adapted to determine a difference between the first image and the second image, and input/output unit adapted to output one or both of a rendered image to represent the difference to a user interface.

14. A color profile comprising:
a first color space conversion algorithm adapted to convert a first set of appearance color values to a first set of device color values specific to a modeled device;
a second color space conversion algorithm adapted to convert the modeled device color values to a second set of appearance values; and
a third color space conversion algorithm adapted to convert the second set of appearance values to a second set of device color values specific to an output device.

15. The color profile of claim 14 further comprising a first input interface adapted to modify the first color space conversion algorithm according to user specified rendering intents.

16. The color profile of claim 15 wherein the user specified rendering intents are one of saturation rendering intents, perceptual rendering intents, and colorimetric rendering intents.

17. The color profile of claim 14 further comprising a second input interface adapted to modify the second set of device color values according to user specified rendering intents.

18. The color profile of claim 16 wherein the user specified rendering intents are one of absolute colorimetric rendering intents and relative colorimetric rendering intents.

19. The color profile of claim 14 wherein the first set of appearance color values originate from a source device.

20. A method comprising:
converting a first set of appearance color values to device color values for a modeled device;
converting the modeled device color values to a second set of appearance color values; and
concatenating the second set of appearance color values with a profile for an output device.

21. The method of claim 20 further comprising modifying the first set of appearance color values according user specified rendering intents.

22. The method of claim 20 further comprising modifying the concatenated output device profile according to one of relative colorimetric rendering intents or absolute colorimetric rendering intents.

23. A method comprising:
embedding at least a color effect portion of at least one of, a first color profile intended for use with a first device, or an abstract profile, into a second color profile intended for use with a second device to form a third profile; and
making the third profile available to output a color image on the second device.

24. The method of claim 23 wherein the abstract profile contains an arbitrary effect.

25. A method comprising:
analyzing a device to appearance conversion table of a color profile for device colors to be created with ink quantities over a specified quantity; and
changing the appearance values corresponding to the device colors over the specified quantity to a notification value.

26. The method of claim 25 wherein the notification value is one selected from a group consisting of:
a bright color;
a bright red;
white; and
paper white.

27. An apparatus comprising:
a processor; and
a color management logic unit adapted to be operated by the processor having a input module adapted to facilitate receiving a color profile, and the color management logic unit further adapted to receive an over-ink threshold value;
a search unit adapted to be operated by the processor to adapted to search device color values for values greater than the over-ink threshold value; and
a modifying unit adapted to be operated by the processor adapted to modify appearance color values in the profile which correspond to the device colors that are over the over-ink threshold.

28. The apparatus of claim 27 wherein the input module is further adapted to receive a notification color value, and the modifying unit is adapted change the appearance color values that correspond to the device colors that are over the over-ink threshold according to the notification color value.

29. The apparatus of claim 24 wherein the notification value is selected from a group consisting of:
a bright color;
a bright red;
white; and
paper white.
